(19) United States
(12) Patent Application Publication
(10) Pub. No.: US 2008/0122746 A1
(43) Pub. Date: May 29, 2008

(54) Plasma display panel and driving method thereof

(76) Inventors: Seungmin Kim, Yongin-si (KR); Sukjae Park, Yongin-si (KR); Inju Choi, Yongin-si (KR); Seungwon Choi, Yongin-si (KR); Seongjoon Jeong, Yongin-si (KR); Taeseong Kim, Yongin-si (KR)

Correspondence Address: ROBERT E. BUSHNELL, 1522 K STREET NW, SUITE 300, WASHINGTON, DC, 20005-1202, US

(21) Appl. No.: 11/979,831

(22) Filed: Nov. 8, 2007

(30) Foreign Application Priority Data
Nov. 24, 2006 (KR) 10-2006-0117146

(51) Int. Cl. G09G 3/28

(52) U.S. Cl. 345/60

(57) ABSTRACT

A plasma display panel device includes a logic controller for preparing a control signal of reset glow due to a load rate, the load rate being calculated from the data signal so that the received signal is converted after an image signal is received from an external source, a driver for generating a driving signal so as to vary the signal in a reset period according to the control signal of reset glow, and a display panel for displaying an image in response to the driving signal from the driver.

### CLAIM OF PRIORITY

This application makes reference to, incorporates the same herein, and claims all benefits accruing under 35 U.S.C.§ 119 from an application for PLASMA DISPLAY PANEL AND DRIVING METHOD THEREOF earlier filed in the Korean Intellectual Property Office on 24 Nov. 2006 and there duly assigned Serial No. 10-2006-0117146.

### BACKGROUND OF THE INVENTION

1. Technical Field

The present invention relates to a plasma display panel device and driving method thereof, and more particularly, to a plasma display panel device and driving method thereof which improves the contrast and expression power of colors so as to minimize a dark discharge in expressing a dark screen, a black color or a picture including a low load rate, especially, in the case of expressing the low gray level.

2. Related Art

Recently, various kinds of flat panel display devices have been developed, and some of them are currently on the market. Such flat panel display devices include a liquid crystal display (LCD), a field emission display (FED), a plasma display panel (PDP) apparatus, and an electro-luminescence (EL) display, etc.

The plasma display panel device of those devices displays a picture by electric discharging, enables embodiment into a digital mechanism perfectly, and is easy to realize in a relatively large screen compared with other display devices.

The plasma display panel device is a picture-on-the-screen device utilizing a discharge system in which the inert gas is injected into the area between two substrates, and the applied voltage causes the generation of electric discharge which emits ultraviolet rays for inducing visible light.

The conventional plasma display panel device is driven by a driving waveform which is subdivided into a sustain period in which the display discharge is generated, a reset period in which the states of the discharge cells for the use of the discharge system are initialized, and an address period in which a discharge cell, among the reset discharge cells in which the display discharge is executed, is selected. In the reset period, the action for controlling the quantity of wall charge is performed to equalize the states of wall charge in the discharge cells existing in the same line or an entire picture. To prepare the sustain period, the discharge cell in which the display discharge is executed in the address period is selected, or the discharge cell in which the display discharge is not executed in a reverse manner is selected. In the sustain period, the discharge of different number of times due to gray level is generated in the selected discharge cell or unselected discharge cell to display a image.

However, a conventional plasma display panel device has insufficient expression power in a dark or a black color for that discharge mechanism, which causes a drop of expression capability in color. More specifically, the discharge which visible light emits is weakly executed during the sustain period, as well as the reset period and the address period, due to the feature of the plasma display panel device. That causes a problem in that the correct expression of colors is not accommodated by unwanted light-emitting at a time when a dark screen is to be expressed. The problem is so serious that users can recognize it in the case of expressing the night on the screen, a black or dark color, and various methods of arranging the image for removing such an operation are performed to improve the quality of the pictures. Especially, these problems are generated in the reset period when initializing the states of the discharging cell rather than the address period when selecting the discharging cell.

### SUMMARY OF THE INVENTION

An object of the present invention is to provide a plasma display panel device and driving method thereof which improves the contrast and expression power of colors so as to minimize a dark discharge in expressing a dark screen, a black color or a picture including a low load rate, especially, in the case of expressing the relatively low gray level.

Another object of the present invention is to provide a plasma display panel device and driving method thereof which controls the dark discharge by reset, and controls the floating voltage applied to the scan electrode or the rising ramp signal of the reset signal to operate selectively according to the plasma apparatus or driving method thereof.

Another object of the present invention is to provide a plasma display panel device and driving method thereof, which varies the peak-voltage of the rising ramp signal for reducing the consumption of unnecessary power, and enables execution of the technology simple.

Another object of the present invention is to provide a plasma display panel device and driving method thereof, which limits the electrode so that the reset discharge is executed by the floating voltage to ensure the operation of the address discharge with the reset glow reduced.

Another object of the present invention is to provide a plasma display panel device and driving method thereof, which is actively applicable to the display of the picture, and which varies the peak-voltage of the rising ramp signal or the potential of the floating voltage due to the load rate so as to maximize the reducing effect of the reset glow due to the load rate.

To accomplish the objects described above, a plasma display panel device according to the present invention comprises a logic controller for preparing a control signal of reset glow due to a load rate, wherein the load rate is calculated from the data signal to which the received signal is converted after an image signal is received from the exterior, a driver for generating a driving signal so as to vary the signal in a reset period according to the control signal of reset glow, and a display panel for displaying an image due to the driving signal from the driver.

The driver can include an address driver, a sustain driver, and a scan driver for supplying the driving signal which includes a reset signal.

The control signal can be a ramp control signal supplied to the scan driver for varying the reset signal, or a floating control signal for controlling the driving signal from the sustain driver during the reset period.

The ramp control signal can be a variable control signal for varying a peak-voltage of the rising ramp signal in the reset signals.

The amplitude of the peak-voltage gradually reduces as the load rate gradually reduces. The floating control signal can be a control signal of floating voltage supplied in response to the rising ramp signal in the reset signals.

The floating voltage can be less than the voltage of the rising ramp signal.

The floating voltage can be supplied while being delayed a little relative to the applying time of the rising ramp signal.

The floating voltage can be supplied to the sustain electrode of the display panel.

The floating voltage can have a section of the sustain potential which sustains the applying voltage, and the sustain voltage amplitude is variable depending on the load rate.

The sustain voltage amplitude gradually increases as the load rate gradually decreases.

The load rate can be at least one of average signal levels including power consumption of a period per unit, the ratio of a display discharging cell to a non-display discharging cell in the period per unit, and gray level weighted values of the display discharging cell.

The period per unit can be a sub-field period or a frame period (or TV field).

A driving method of a plasma display panel device according to the present invention comprises the steps of preparing a data signal to receive an image signal, calculating a load rate from the data signal, preparing a control signal of reset glow due to the load rate, and executing a control operation of reset glow in response to the control signal of reset glow.

The control signal can be a ramp control signal supplied to the scan driver for varying the reset signal, or a floating control signal for controlling a driving signal from the sustain driver during the reset period.

The ramp control signal can be a variable control signal for varying a peak-voltage of the rising ramp signal in the reset signals.

The amplitude of the peak-voltage gradually reduces as the load rate gradually reduces.

The floating voltage can be less than the voltage of the rising ramp signal.

The load rate can be at least one of average signal levels including power consumption of a period per unit, the ratio of a display discharging cell to a non-display discharging cell in the period per unit, and gray level weighted values of the display discharging cell.

The period per unit can be a sub-field period or a frame period.

The step of preparing the control signal or executing the control operation further comprises: selecting the peak-voltage due to the load rate, preparing the ramp control signal including the value of the peak-voltage selected, and applying the rising ramp signal due to the ramp control signal.

Preparing the control signal or executing the control operation further comprises: selecting the sustain potential which constantly sustains the potential of the floating voltage due to the load rate, preparing the floating control signal including the value of sustain potential, applying the rising ramp signal of the reset signals, and supplying the floating voltage in response the rising ramp signal.

The floating voltage can be supplied while being delayed a little relative to the applying time of the rising ramp signal.

The sustain voltage amplitude increases as the load rate decreases.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram illustrating the construction of a plasma display panel apparatus according to the present invention.

FIGS. 2a and 2b schematically illustrate the load rate;

FIG. 3a illustrates a waveform relating to operation of the reset glow control by a ramp control signal;

FIG. 3b illustrates a waveform relating to operation of the reset glow control by a floating control signal;

FIG. 4 is a block diagram illustrating the signal transfer flow of each element in FIG. 1;

FIG. 5 is a schematic diagram of a waveform illustrating an example of rectangular waveforms applicable to the plasma display panel device of the present invention;

FIG. 6 is a block diagram schematically illustrating a connecting relation with the driver and the electrode arrangement of the display panel applicable to the present invention;

FIG. 7 is a perspective view illustrating the structure of the discharge cell applicable to the present invention;

FIG. 8 is a flow chart illustrating a control method of reset glow according to the present invention;

FIG. 9 is a flow chart illustrating a method for representing in more detail the steps S30 and S40 of FIG. 8; and

FIG. 10 is a flow chart illustrating another method for representing in detail the steps S30 and S40 of FIG. 8.

### DETAILED DESCRIPTION OF THE INVENTION

The invention is described in detail with reference to the accompanying drawings, in which exemplary embodiments of the invention except the object are illustrated. This invention can, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions can be exaggerated for clarity.

Exemplary embodiments of the present invention will be described in a more detailed manner with reference to the drawings. Also, three-electrode surface discharge type, selective write-mode, and single scan-mode in the various plasma display panel apparatus will be explained by way of examples for describing embodiments of the invention, but the invention is not limited thereto.

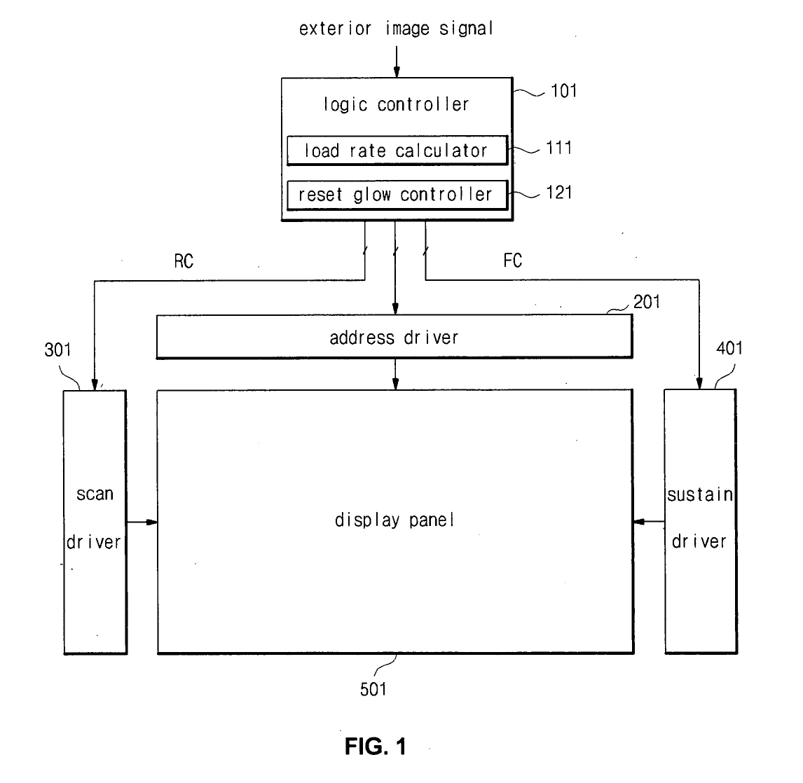

FIG. 1 is a schematic diagram illustrating the construction of a plasma display panel device according to the present invention.

Referring to FIG. 1, the plasma display panel apparatus according to the present invention includes a logic controller 101, an address driver 201, a scan driver 301, a sustain driver 401, and a display panel 501. Also, the logic controller 101 includes a load rate calculator 111 and a reset glow controller 121.

The logic controller 101 converts image signals received from the image processor (not shown) or the exterior into data signals DS in a shape which is capable of processing in the address driver 201, the scan driver 301, and the sustain driver 401. Especially, the logic controller 101 computes a load rate LR when converting the data signal of the image signal, and performs the reset glow control RGC to the scan driver 301 or sustain driver 401 due to the load rate. The logic controller 101 includes the reset glow controller 121 and the load rate calculator 111 for calculating the load rate. The logic controller 101 generates floating control signals FC supplied to the sustain driver 401 or ramp control signals RC supplied to the scan driver 301 due to the control operation in controlling the reset glow. Here, the load rate and the reset glow control will be described in more detail by drawings.

The address driver 201 supplies address signals to the address electrode of the display panel 501 during the address period under control of the logic controller 201. The address driver 201 receives data signals DS from the logic controller 101.

The scan driver 301 supplies reset pulses RP, scan pulses SP, and sustain pulses SUS_Y to the scan electrode of the display panel 501 under control of the logic controller 101. Especially, the scan drier 301 performs control operation of the reset glow by the ramp control signal RC from the logic controller 101 due to the load rate. More specifically, the scan driver 301 supplies the separate peak voltage of the rising lamp during the reset period RP to the scan electrode according to the ramp control signal RC. The scan driver 301 reduces reset glow emission by the rising lamp RP to thereby raise expressive power of dark tint in the case of a low load rate. The scan driver 301 including the ramp signal supplier which supplies the reset signals RP of another peak voltage due to the ramp control signals RC, the scan signal supplier which supplies the scan signals SP for selecting the charge cell, and the sustain signal supplier which supplies the sustain signals SUS_Y for display-discharging can be provided.

The sustain driver 401 supplies the sustain signals SUS_X to the sustain electrode of the display panel 501 under control of the logic controller 101. Especially, the sustain driver 401 performs control operation of the reset glow by the floating control signal from the logic controller 101 due to the load rate. More specifically, the sustain driver 401 supplies the floating voltage FV to the sustain electrode while the rising ramp signal RR is being applied to the scan electrode during the reset period REP in accordance with the floating control signal FC. The sustain driver 401 diminishes a voltage difference of scan electrode and sustain electrode to thereby prevent the generation of the dark discharge between the scan electrode and the sustain electrode during the applying period of the rising ramp signal RR. As a result, the expressive power of dark tint in the low load rate can be raised to prevent unnecessary discharge which can be generated during the applying period of the rising ramp signal in the reset period and discharge of visible light thereof. The sustain driver 401, including the floating voltage supplier which supplies the floating voltage FV and the sustain pulse supplier which supplies the sustain pulse SUS_X for display-discharge, can be provided.

The display panel 501 includes a plurality of discharging cells, an address electrode group, a scan electrode group, and a sustain electrode group. Dielectric layer, protective film layer, barrier rib, and phosphor substance layer can be formed in the discharging cell of the display panel 501, the discharging cell being disposed in crossing portion of between the address electrode group and the scan electrode group, or between the address electrode group and the sustain electrode group intersect. The display panel 501, which emits according to the driving signal supplied by the address driver 201, the scan driver 301, and the sustain driver 401, generates images. The structure applicable to the discharging cell and the display panel 501 will be described in detail later.

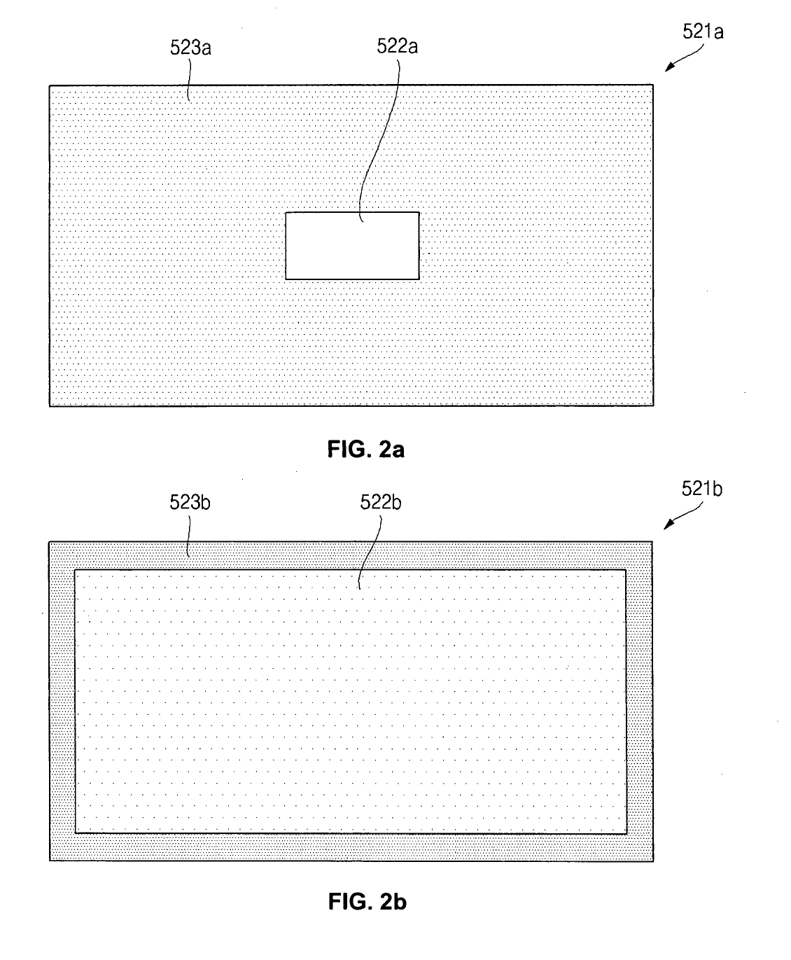

FIGS. 2a and 2b schematically illustrate the load rate, wherein FIG. 2a illustrates the display panel in the case of more cells that are not discharging compared to the number of the cells that are discharging, and FIG. 2b illustrates the display panel in the case where cells that are discharging display only low gray level.

Referring to FIGS. 2a and 2b, the load rate can be changed according to various conditions such as data processing performance, display capability of the image, the aspects of the driving signals, and the characteristics of the plasma display panel device. In the above conditions, the data available for the load rate depicted in FIGS. 2a and 2b illustrates schematically. The load rate can be set on the basis of the power consumption per one frame or per a sub-field simply. Here, the sub-field implies a period of one unit which an inherent weighted value has imposed in the case where one frame (or TV field) is divided into multiple sections including different weighted values and the image is displayed in a separate number of display discharge times due to the weighted value. The frame implies the period of a screen as a maximum basic foundation among a plurality of image screens for making specific images as described above. The definition of the sub-field and the frame is known in the related art.

The load rate can be set on the basis of the power consumption or average signal level. It is possible to use the average brightness of the display discharging cell as the average signal level, the ratio of the display discharging cell vs. non-display discharging cell as depicted in FIGS. 2a and 2b wherein various methods capable of producing average signal level as well can be used. The power consumption and average signal level present a typical example of the load rate, which is not limited to the present invention. The definition of the load rate can be differently established according to the generation or disappearance feature of space charge in low gray level, for example, inherent aspects of the plasma display panel device for which the technical concept of the invention is adopted.

FIG. 2a illustrates the display panel in the case where the number of display discharging cells which performs display discharge is less than that of the non-display discharging cells for the period of a sub-field or a frame. Here, the period of comparing the number of display discharging cells with that of the non-display discharging cells can be fixed temporarily. The image to the display panel becomes dark in the case where the number of the display discharging cells 522a is relatively less than that of non-display discharging cells 523a, i.e., the area of the display discharging cells 522a as depicted in FIG. 2a. Namely, a dark image can be generated when the number of the display discharge 522a is small. Consequently, the load rate can be easily calculated by comparing the number of the display discharging cell 522a with that of the non-display discharge 523a.

Although the display discharge was performed so as to be restricted within the central area of the display panel 521a illustrated in FIG. 2a, the display discharging cell 522a can be spread all over the display panel 521a.

FIG. 2b illustrates that the display weighted value of the display discharging cell is entirely low although the number of the display discharging cells 522b is more than that of non-display discharging cell 523b. The plasma display panel device utilizes the driving method for dividing a plurality of one frame period into a plurality of sub-field sections. In this case, the method for differentiating the number of times in the display discharge or the weighted value is used for every sub-field. Although a treater number of the display discharging cells 522b versus non-display discharging cells 523b exists in the sub-fields including low weighted value, a dark screen is represented. On calculating the load rate using the ratio of the current weighted value to the display discharging cell 522b, the brightness of the image generated on the screen can be easily concluded. The load rate can be represented more clearly by employing a mix of the load rate as described in FIG. 2a and that in FIG. 2b. The load rate of FIGS. 2a and 2b described above is an explanation of the invention for understanding of the defined load rate, which is not limited to the invention and is applicable to various adaptations.

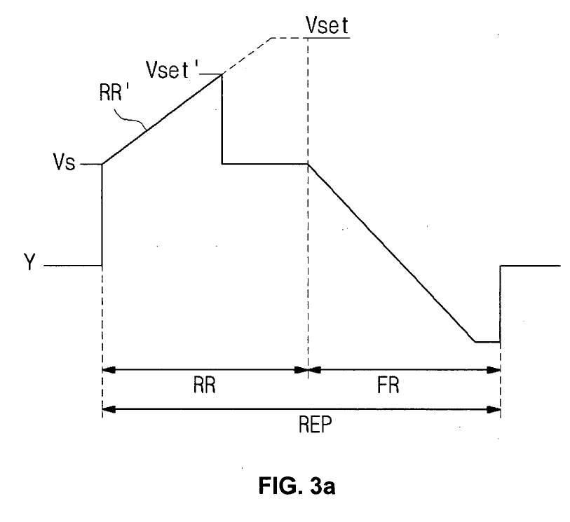

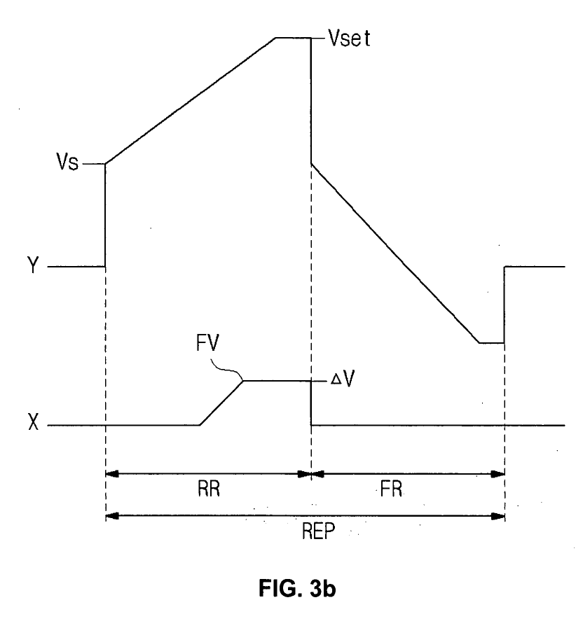

FIGS. 3a and 3b illustrate a rest waveform for explaining the operation of a reset glow control, wherein FIG. 3a illustrates a waveform relating to operation of the reset glow control by a ramp control signal RC, and FIG. 3b illustrates a waveform relating to operation of the reset glow control by a floating control signal FC.

Referring to FIG. 3a, as described above, the logic controller 101 converts the exterior image signal into the data signal DS and calculates the load rate at the same time. Upon calculation of the load rate, the logic controller 101 supplies the control signal RC, FC for operating the reset glow control to the scan driver 301 or the sustain driver 401 according to the load rate. The ramp control signal RC of the control signals FC, RC is transferred from the logic controller 101 to the scan driver 301, which is the control signal for shifting a peak-voltage of the rising ramp signal RR as depicted in FIG. 3a. Namely, the magnitude of peak-voltage Vset of the rising ramp signal for controlling the reset glow can be changed in the case of low load rate (or when expressing a dark screen or dark color). The rising ramp signal of adjustment RR′ to which the peak-voltage is changed is supplied to the scan electrode by shortening the applied period of the rising ramp signal RR. When the load rate is low, the peak-voltage of adjustment of low potential lower than the peak-voltage in the case of high load rate is supplied to the scan electrode. More specifically, the discharging cell that the reset signal RP applied is initialized during the applying period of the rising ramp signal in reset period. The rising ramp signal RR and falling ramp signal FR play a different role in detail with the discharging cell being initialized during applying of the falling ramp signal in the reset period. The rising ramp signal RR gradually rises from the scan voltage Vs to reach the peak-voltage Vset, and thereby the wall charge is generated somewhat excessively and filled inside the discharging cell. The wall charge which was generated excessively disappears to a considerable extent by the falling ramp signal, with only the quantity necessary to address-discharge remaining inside the discharging cell. Upon application of the rising ramp signal to the scan electrode, the wall charge is generated excessively and the reunion among wall charges generated is advancing simultaneously. The excited energy which discharged ultraviolet rays is supplied to the phosphor substance, which generates unnecessary visible light. The discharging among the scan electrode, sustain electrode, and address electrode can be generated in part due to the rising ramp signal RR. The energy that the inert gases retained can be released in type of ultraviolet rays and thereby visible light can be generated. In case the load rate is low in the present invention, excessive generation of the wall charge can be suppressed, and the ray emission of the applying period of the rising ramp signal RR can be minimized so as to prevent discharging between the scan electrode and the other electrode. The reset glow controller 121 of the logic controller 101 transfers the ramp control signal to the scan driver with the ramp control signal being enabled to reduce the magnitude of the peak-voltage of adjustment. As described in FIG. 3a, the rising ramp signal of adjustment retains the applying period of remaining rising ramp signal as the scan voltage Vs since supplying of the adjusted peak-voltage Vset′. However, the sustain section of the scan voltage Vs can be omitted in consideration of the feature or the method of the plasma display panel device. The adjusted peak-voltage can be retained for certain times, which is not limited to the present invention.

FIG. 3b illustrates a floating voltage FV supplied to the sustain electrode by a floating control signal. Unlike FIG. 3a, the reset signal RP applied to the scan electrode is not changed in FIG. 3b, and the floating voltage FV is applied to the sustain electrode during the applying period of the rising ramp signal RR in the reset signal RP of the scan electrode. As the sustain potential ΔV of the floating voltage FV is variable according to the load rate, if the load rate is low, the sustain potential goes up, and if the load rate is high, then the sustain potential goes down. Although FIG. 3b illustrates that the floating voltage ascends to the sustain potential with more or less gradient, it can provide with the rectangular wave without gradient. The floating voltage FV can be applied before the period that the rising ramp signal RR is applied. However, since the floating voltage is applied to prevent the dark discharge which the reset glow emits, to apply the floating voltage in the latter portion of the period in which the rising ramp signal RR is applied represents the effect of proper reset glow reduction. It is considered according to the feature of the plasma display panel device, which is not limited to the present invention. Since the voltage of reference potential is applied to the scan electrode during the applying period of the falling Ramp signal FR, the positive bias voltage can be applied during that period. The floating voltage FV is supplied to the sustain electrode according to the floating control signal FC applied to the sustain driver 401 from the reset glow controller 121 of the logic controller 101.

Concerning the difference between FIG. 3a and FIG. 3b, the voltage differences between the scan electrode and sustain electrode, and between the scan electrode and the address electrode, can be reduced by changing the amplitude of peak-voltage of the rising ramp signal in the case of FIG. 3a, which is the purpose for reducing the differences. Thereby, that accommodates the effect such that the discharge that emits reset glow between the scan electrode and the sustain electrode can be reduced, and the discharge between the scan electrode and the address electrode can be reduced. There is a feature in that the voltage difference between the scan electrode and the address electrode is sustained in FIG. 3b, wherein the discharge between two electrodes is prevented by reducing the difference of voltage between the scan and the sustain electrodes. As there is the difference described in FIGS. 3a and 3b, it can be utilized selectively in consideration of the plasma display panel device that technical features of the present invention are employed. Since the discharge between the scan and sustain electrodes as well as the discharge between the scan and address electrodes can be prevented in FIG. 3a, the situation that the wall charge condition for the address charge hereafter is not satisfied can be generated. Because only the discharge between the scan electrode and the sustain electrode can be prevented, the condition of the wall charge for the address discharge is easy to be ensured. It is preferable to select a proper method between the method of FIG. 3a and that of FIG. 3b, or to use it together with another.

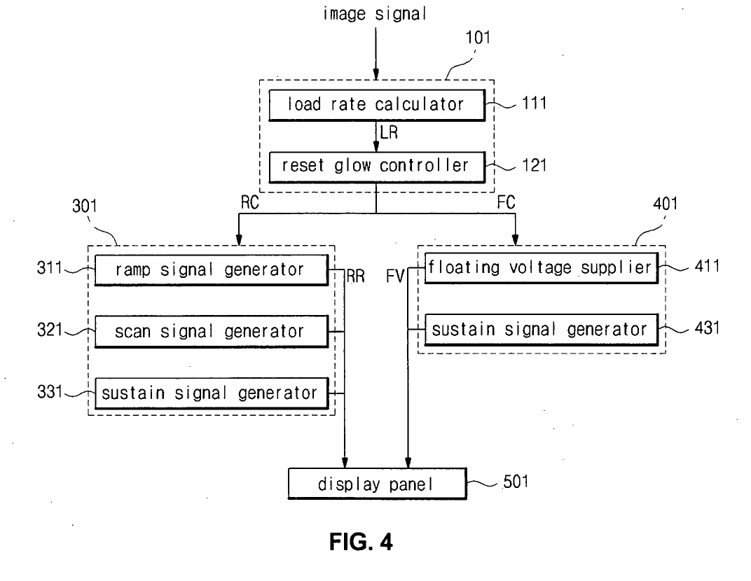

FIG. 4 is a block diagram illustrating the signal transfer flow of each element in FIG. 1.

Referring to FIG. 4, when an image signal from the exterior is transferred to a plasma display panel device, the image signal converts into the data signal DS by a signal conversion circuit like a sub-field generator (not shown). The load rate calculator 111 in the logic controller 101 calculates the load rate from the image signal or data signal, and provides the controller of reset glow 121 with the calculated load rate.

The reset glow controller 121 generates the ramp control signal RC or floating control signal FC for controlling the scan driver 301 or the sustain driver 401 according to the accepted load rate. The reset glow controller 121 transfers the prepared ramp control signal RC or the floating control signal FC to the scan driver 301 or the sustain driver 401. The reset glow controller 121 prepares at least one signal of the ramp control signal and the floating control signal according to the predetermined scheme, and can supply it to the one driver of the scan driver 301 and the sustain driver 401.

In the case of preparation of the ramp control signal RC from the reset glow controller 121, the ramp control signal RC is transferred to the ramp signal generator 311 in the scan driver 301. The ramp signal generator 311 supplies the rising ramp signal RR which adjusts the peak-voltage Vset to the display panel 501 according to the accepted ramp control signal RC.

In the case of preparation of the floating control signal FC from the reset glow controller 121, the floating control signal FC is transferred to the floating voltage supplier 411 in the sustain driver 401. The floating voltage supplier 411 supplies the floating voltage FV, including variable sustain potential ΔV according to the load rate, to the display panel 501.

When the reset period finishes, the scan signal generator 321 in the scan driver 301 supplies the scan signal SP for selecting the discharging cell to the display panel 501, and continuously supplies the sustain signal SYS-Y by the sustain signal generator 331 to the display panel 501.

The sustain signal generator 431 in the sustain driver 401 supplies the sustain signal SUS_X and SUS_Y alternatively to the display panel 501 by the scan driver 301. The sustain signal generator 331, 431 can be included in at least one driver of the scan driver 301 and the sustain driver 401 in the course of explanation via FIG. 4; in this case, the sustain signal can be the alternative waveform that alternates from the sustain voltage of positive polarity to that of negative polarity.

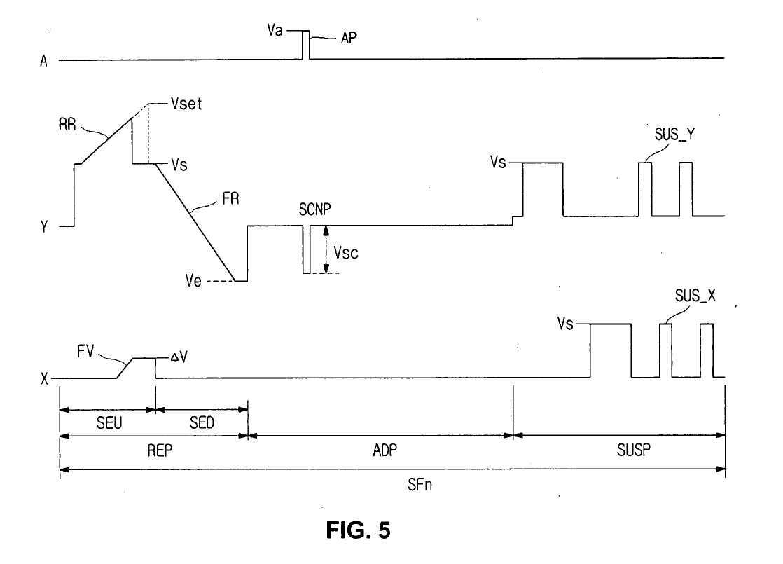

FIG. 5 is a schematic diagram of a waveform illustrating an example of rectangular waveforms applicable to the plasma display panel device of the present invention. The sustain signal of FIG. 5 is supplied alternatively by the scan driver and the sustain driver, wherein bias voltage applied to each electrode can be varied a little when applying actually.

With reference to FIG. 5, the rectangular waveform for operating the plasma display panel device includes a reset period REP for initializing the discharging cells, an address period ADP for selecting the discharging cell, and a sustain period SUSP that the display discharge is executed.

The rising ramp signal RR is applied to the scan electrode Y in the set-up period SEU, the rising ramp signal being applied during the reset period that the sub-field begins. The rising ramp signal RR can be controlled to represent a different peak-voltage according to the load rate previously described. A voltage of 0V is applied to the address electrode A in the same period. The voltage of the scan electrode by the rising ramp signal of this set-up period gradually rises from the sustain voltage Vs to the peak-voltage Vset which is higher than the sustain voltage. The dark discharge which is emitted between the scan electrode Y and the sustain electrode X, and between the scan electrode and the address electrode, can be generated in the display cell by the rising ramp signal. The generation of the dark discharge is prevented by making the peak-voltage low, especially in the case of the low load rate according to the load rate in the present invention. Although the user seldom recognizes this dark discharge in the case of displaying a bright picture, most of the users recognize it in the case of displaying a dark picture, which acts as a factor in deteriorating the representing quality. Thereby, in the situation of displaying the dark picture, i.e. low load rate rather than the situation of displaying the bright picture, it is preferable to supply the rising ramp signal RR where Vset is low. Since minimizing of the discharge in the set-up period SEU is the purpose to pursue, it needs to check the proper range of the peak-voltage Vset in the plasma display panel device individually, since the discharge environment for address discharge is not prepared in the case of perfect interception of the discharge, which can cause the failure of the address discharge.

Unlike this, the floating voltage FV can be applied to the sustain electrode X in the set-up period SEU as another method for minimizing the generation of the dark discharge. The floating voltage FV minimizes the generation of dark discharge between the scan electrode Y and the sustain electrode Y, thereby improving the expression of a dark screen and the power of color expression in a dark tint party.

Following the set-up period SEU, the falling ramp signal FR by which the voltage gradually falls from the sustain voltage Vs to the elimination voltage Ve of negative polarity is supplied to the scan electrode Y in the period of the set-down SED in which the falling ramp signal in the reset period is applied. The bias voltage of positive polarity can be supplied to the sustain electrode X in the set-down period SED. The condition of wall charge in the discharging cell can be most suitable to an address by the falling ramp signal FR of the set-down period SED. The wall charge which was excessively generated in the set-up period SEU mostly disappeared in the set-down period SED so as to remain the quantity required to the address charge.

In the following address period ADP, the scan pulse SCNP is sequentially applied to the scan electrode Y. At the same time, an address signal AP is applied to the address electrode A after synchronizing with the scan pulse SCNP. The wall charge arrangement for the display discharge is accomplished in the display cell where the display charge is executed by the scan pulse SCNP and the address signal AP.

The sustain signal SUS_Y, X is alternatively applied to the scan electrode and the sustain electrode during the sustain period SUSP. The charge cells selected by the address discharge execute the display discharge for every sustain signal to display the picture. The sustain signal SUS_Y, X can be alternatively supplied in at least one electrode of the scan electrode Y and the sustain electrode Z. The display discharge can be performed by the sustain signal which alternates from the sustain voltage of positive polarity Vs to that of negative polarity −Vs.

The rising ramp signal RR or the floating voltage FV in the set-up period SEU previously described can be changed linearly according to the ratio of the load rate, and can be provided with fixed value constantly according to the section of the load rate. In the section that the ratio of the load rate is 1% to 3%, the peak-voltage or the floating voltage corresponding to the first voltage can be supplied, and can be supplied to represent in different voltage in different area. Those skilled in the related art can modify it according to the features of the plasma display panel device.

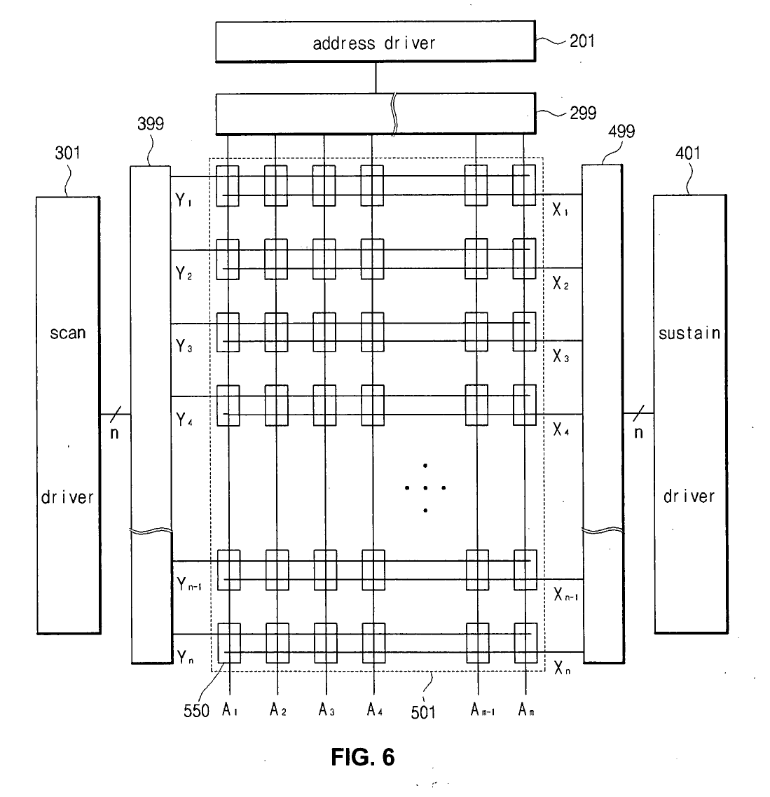

FIG. 6 is a block diagram schematically illustrating a connecting relation with the driver and the electrode arrangement of the display panel applicable to the present invention.

Referring to FIG. 6, the display panel 501 includes discharging cell 550 in which the generated plasma discharge is incorporated with each and every crossing point of the scan electrode Y1 to Yn, the sustain electrode X1 to Xn, and the address electrode A1 to Am.

The scan electrode Y1 to Yn supplies the scan signal SP and sustain signal SUS_Y from the scan driver 301 to the discharging cell 550 for executing display discharge and the selection of the discharging cell 550 as well. Especially, the scan electrode Y1 to Yn supplies the rising ramp signal so that the peak-voltage Vset varies according to the load rate to the discharging cell 550, to thereby minimize the generation of the dark discharge in a low gray level and dark picture or the picture of low load rate.

The sustain electrode X1 to Xn supplies the floating voltage FV and the sustain signal SUS_X from the sustain driver 401 to the discharging cell to thereby minimize the dark discharge in the reset period REP and to execute the display discharge as well.

The address electrode A1 to Am supplies the address signal AP which synchronizes with the scan signal RP from the address driver 201 to the discharging cell 550 for selecting the discharging cell so that the display discharge is performed.

The address driver 201, the scan driver 301, and the sustain driver 401 couple the electrodes formed on the display panel 501 by TCP (Tape carrier package) 299 or FFC (Flexible flat cable) 399, 499.

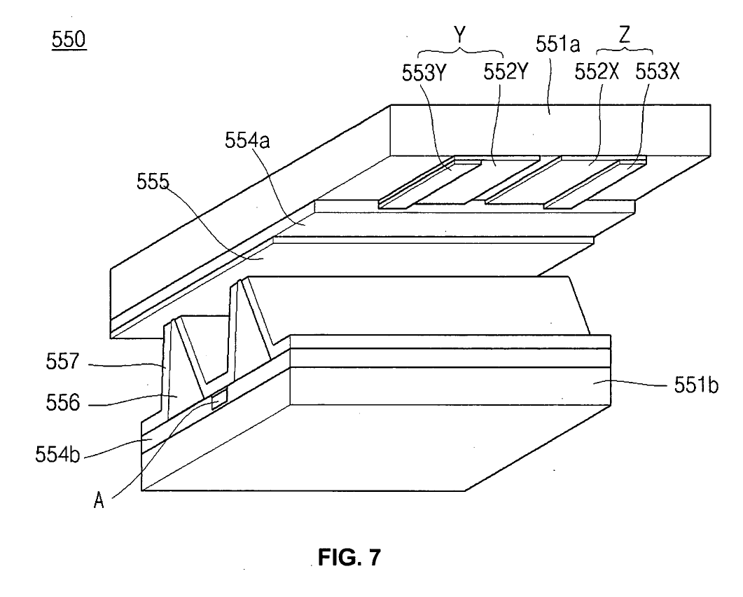

FIG. 7 is a perspective view illustrating the structure of the discharging cell applicable in the present invention, which describes 3-electrode surface discharge type and the upper 2-electrode type plasma display panel.

With reference to FIG. 7, the display panel 501 includes a front side substrate 551a, a back side substrate 551b, an upper electrode Y, X, a dielectric layer 554: 554a, 554b, a protective film 555, a lower electrode A, a barrier rib 556, and a phosphor substance layer 557.

The upper electrode Y, X is formed on the substrate surface of the front side substrate 551a which meets the back side substrate 551b, and includes the scan electrode Y and the sustain electrode X. The lower electrode A is formed to intersect the upper electrode Y, X on the substrate surface of the back side substrate 551b which meets the front side substrate 551a, and which is used as the address electrode A. The upper electrode Y, X includes a transparent electrode 552: 552Y, 552× and a metal bus electrode 553: 553Y, 553X respectively. Although the metal bus electrode 553 is formed on the one side of the transparent electrode 552 in FIG. 7, various modifications are possible, and the present invention is not limited to the present disclosure.

The transparent electrode 552 is made using mainly indium tin oxide ITO, indium zinc oxide IZO, indium tin zinc oxide ITZO and an equivalent thereof. The metal bus electrode 553 is made using chrome, copper, silver, gold or the equivalent metal thereof, and plays a role of reducing the voltage dropping of signal voltage so as to compensate for high resistance of the transparent electrode 552. The upper dielectric layer 554a is formed on the front side substrate 551a on which the scan electrode Y and the sustain electrode X are formed, and the protective layer 555 is formed on the upper dielectric layer 554a.

The protective layer 555 prevents damage of the upper dielectric layer 554a by the sputtering generated in discharging the plasma, and raises the discharge efficiency of a secondary battery. MgO can be used as the protective layer 555.

Meanwhile, lower dielectric layer 554b, barrier rib 556 and phosphor substance layer 557 are formed on the lower substrate 551b. Although the barrier rib is formed in one direction in FIG. 7, modification of various shapes is possible, and the present invention is not limited to the shape depicted in FIG. 7.

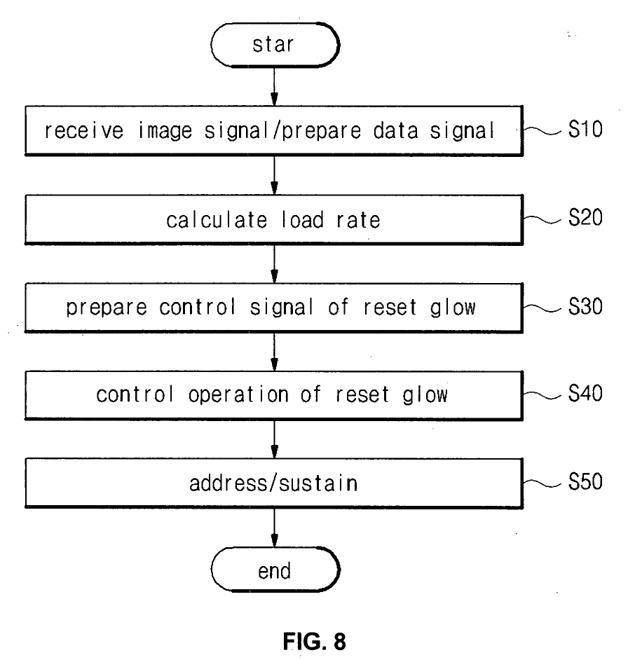

FIG. 8 is a flow chart illustrating a control method of reset glow according to the present invention. Referring to FIG. 8, the control method of the reset glow includes a step of receiving image signals (S10), a step of calculating the load rate (S20), a step of preparing control signals of the reset glow (S30), a step of operating reset glow control (S40), and a step of address or sustain (S50).

Receiving image signals (S10) is the step wherein the logic controller receives the image signal from the exterior and converts it into the data signal DS. The address driver, the scan driver, and the sustain driver display the picture through the display panel using converted data signals DS.

Calculating the load rate (S20) is the step for calculating the load rate for the control operation of the reset glow. The logic controller calculates the load rate LR by a frame or a temporary period in the process of converting the image signal into the data signal DS. Since the description regarding the load rate LD is specified in detail by use of FIG. 2, more explanation about this is omitted.

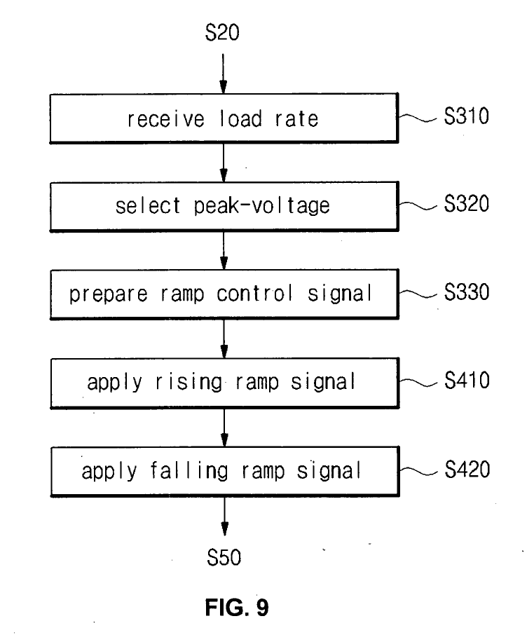

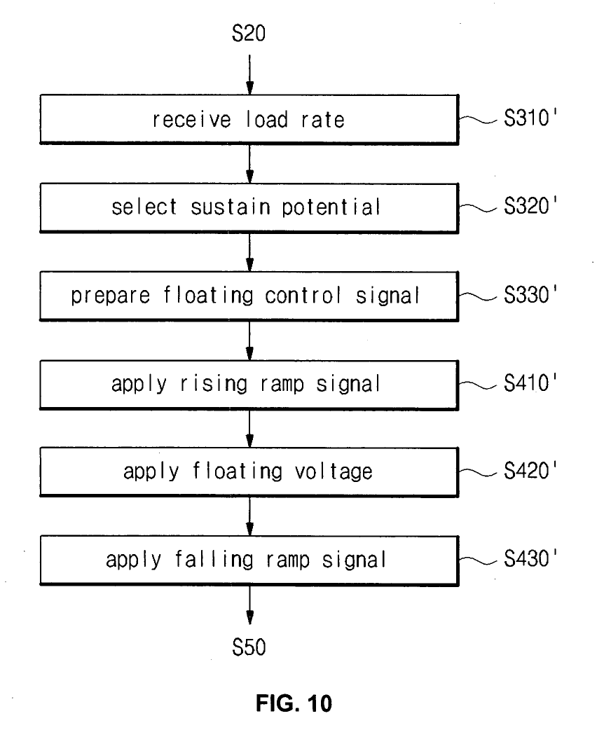

The step of preparing control signals of the reset glow (S30) determines whether the control operation of the reset glow is required according to the calculated load rate, and prepares the control signal for the scan driver or the sustain driver to perform the controlling operation of the reset glow in the case wherein the control operation of the reset glow is required. As described above, the reset glow controller of the logic controller receives the load rate from the load rate calculator, and prepares the control signal upon receiving the load rate that meets a condition previously stored. The control signal prepared at the time where the load rate is low is the signal which controls the operation of the scan driver or the sustain driver for raising the expression power of a dark color and a dark picture in the case of a dark image and an expression image of relatively low gray level. This will be described in more detail with reference to FIGS. 9 and 10.

In the step of operating the reset glow control (S40), the control signal prepared from the logic controller is transferred to the driver which executes the operation of reducing the reset glow according to the control signal. The step of operating the reset glow control (S40) includes a controlling method of the rising ramp signal RR and an applying method of the floating voltage FV to the sustain electrode, which is preferable to select properly by determining inherent factors, such as the features and driving method of the plasma display panel device.

In the step of address/sustain (S50), the address discharge for selecting the discharging cell is executed so that the display discharge is performed after the reset period and the control operation of rest glow is executed, and the sustain discharge is executed so that the display discharge is performed in the selected discharging cell. After finishing the step of address or sustain (S50), the steps previously described are processed repeatedly.

FIG. 9 is a flow chart illustrating a method for representing in more detail the steps S30, S40 in FIG. 8, and FIG. 10 is a flow chart illustrating another method for representing in detail the steps S30, S40 in FIG. 8.

Referring to FIG. 9, the steps of S30 and S40 can be subdivided into the steps of receiving the load rate (S310), selecting the peak-voltage (S320), preparing the ramp control signal (S330), applying the rising ramp signal (S410), and applying the falling ramp signal (S420).

In the step of receiving the load rate (S310), the controller of reset glow receives the load rate calculated from the load rate calculator.

Selecting the peak-voltage (S320) is a step in which the proper peak-voltage Vset is selected according to the load rate received. In this step, the peak-voltage value designated due to the range of the load rate is selected, or the peak-voltage Vset in proportion to the load rate can be calculated. Subdividing constant range of the load rate into several sections, the peak-voltage Vset can be selected by estimating the section that the received load rate belongs to, after deciding in advance the peak-voltage used in the each section and storing. In the case wherein the load rate and the peak-voltage are related by a constant ratio, for example, in the case of a proportionate relationship wherein the peak-voltage increases 10V when the load rate increases 1%, the peak-voltage can be calculated and designated according to the related equation.

In the step of preparing the ramp control signal (S330), the ramp control signal RC for controlling the operation of the scan driver is prepared so as to supply to the scan electrode a rising ramp signal, wherein the scan driver is rising to the corresponding peak-voltage Vset. When the scan driver supplies the rising ramp signal RR to the scan electrode, the controller of the reset glow can supply the supply cut-off signal to the scan driver, whereas the potential of the rising ramp signal indicates the same potential as the peak-voltage selected.

In the step of applying the rising ramp signal (S410), when the ramp control signal RC is transferred, the scan driver rises to the peak-voltage Vset that the ramp control signal RC designated, and then supplies the rising ramp signal RR to the scan electrode.

After the supply of the rising ramp signal RR, the scan driver supplies the falling ramp signal FR to the scan electrode when getting to the set-down period.

FIG. 10 is a flow chart illustrating the case of selecting the method for supplying the floating voltage to the sustain electrode as the control operation of the reset glow.

With regard to FIG. 10, the load rate is received from the load rate calculator. Upon reception of the load rate LR, sustain potential ΔV of the floating voltage FV is selected in the step of selecting sustain potential (S320′). The selection of sustain potential ΔV is analogous to the selecting method of the peak-voltage Vset previously described. It can selectively use sustain potential ΔV designated by the range of the load rate, or change sustain potential ΔV due to the correlation between the load rate LR and the sustain potential ΔV. It is preferable to decide simultaneously the applying time of the floating voltage FV corresponding to sustain potential ΔV in the step of selecting sustain potential ΔV.

In the step of preparing the floating control signal (S330′), when sustain potential ΔV is selected, the floating control signal FC which controls the sustain driver is prepared, and is transferred to the sustain driver for supplying the floating voltage corresponding to the sustain potential.

In the step of applying the rising ramp signal (S410′), the rising ramp signal RR is applied to the scan electrode by the scan driver during the set-up period SEU.

In the step of applying of the floating voltage (S420′), when the rising ramp signal RR is applied to the scan electrode, the rising rap signal RR is applied due to the floating signal FC in the sustain driver, and the floating voltage FV is supplied to the sustain electrode after predetermined time.

Finally, in the step of applying the falling ramp signal (S430′), when the set-up period SEU is finished, the reset period REP is finished since the scan driver supplies the falling ramp signal FR to the scan electrode.

Table 1 illustrates the brightness variation according to the change of the peak voltage in the plasma display panel to which the rising ramp signal is applied.

TABLE 1

| Difference with existing | |
|---|---|
| peak-voltage [V] | brightness (cd/m²) |
| 0 | 3.24 |
| −10 | 3.16 |
| −20 | 3.06 |
| −30 | 2.99 |
| −40 | 2.9 |
| −50 | 2.81 |
| −60 | 2.74 |

As described in Table 1, the brightness of the reset glow decreases when dropping the potential of the peak-voltage against the existing potential in the image of low gray level. With regard to Table 1, the brightness of 3.24 cd/m² is approximately illustrated when the rising ramp signal RR, including the existing peak-voltage Vset, is applied to the display panel. Although it is difficult for the user to confirm that the brightness value expresses bright image, i.e., the image of high gray level, the difference in small quantity of light can be easily recognized where the dark image of low gray level like the night is expressed. However, it can be seen that the difference of approximately 0.5 cd/m² in brightness is generated in comparison with unchanged supply of the peak-voltage Vset when supplying the adjusted peak-voltage Vset, that is, adjusted by 60V lower than the peak-voltage Vset according to the present invention. The generation of reset glow is reduced due to the supply of the adjusted peak-voltage Vset, which means an increase in expression power in an image of low gray level. It can increase the expression power of the color in view of the facts according to the present invention.

The plasma display panel device and driving method thereof according to the invention can increase the contrast and expression power of colors so as to minimize a dark discharge in expressing a dark screen, a black color or a picture including a low load rate, especially in the case of expressing the low gray level.

The plasma display panel device and driving method thereof easily controls the dark discharge by reset, and controls the floating voltage applied to the scan electrode or the rising ramp signal of the reset signal so as to operate selectively according to the plasma apparatus or driving method thereof.

The plasma display panel device and driving method thereof varies the peak-voltage of the rising ramp signal so as to reduce the consumption of unnecessary power, and so as to enable simple execution of the technology.

The plasma display panel device and driving method thereof limits the electrode in that the reset discharge is executed by the floating voltage to ensure the operation of the address discharge with the reset glow reduced.

The plasma display panel device and driving method thereof is actively applicable to the display of the picture and varies the peak-voltage of the rising ramp signal or the potential of the floating voltage due to the load rate so as to maximize the reducing effect of the reset glow due to the load rate.

While this invention is described in connection with what is presently considered to be practical exemplary embodiments, the invention is not limited to the disclosed embodiments. Moreover, the invention is intended to cover various modifications and equivalent arrangements included within the spirit and scope of the appended claims.

What is claimed is:

1. A plasma display panel device, comprising:
a logic controller for preparing a control signal of reset glow due to a load rate, wherein the load rate is calculated from the data signal to which a received signal is converted after an image signal is received from an external source;
a driver for generating a driving signal so as to vary the driving signal in a reset period according to the control signal of reset glow; and
a display panel for displaying an image in response to the driving signal from the driver.

2. The plasma display panel device as claimed in claim 1, wherein the driver includes an address driver, a sustain driver, and a scan driver for supplying the driving signal which includes a reset signal.

3. The plasma display panel device as claimed in claim 2, wherein the control signal is one of a ramp control signal supplied to the scan driver for varying the reset signal and a floating control signal for controlling the driving signal from the sustain driver during the reset period.

4. The plasma display panel device as claimed in claim 3, wherein the ramp control signal is a variable control signal for varying a peak-voltage of the rising ramp signal in the reset signal.

5. The plasma display panel device as claimed in claim 4, wherein the amplitude of the peak-voltage decreases as the load rate decreases.

6. The plasma display panel device as claimed in claim 3, wherein the floating control signal is a supplying control signal of floating voltage supplied in response to a rising ramp signal in reset signals.

7. The plasma display panel device as claimed in claim 6, wherein the floating voltage is less than a voltage of the rising ramp signal.

8. The plasma display panel device as claimed in claim 7, wherein the floating voltage is supplied while being delayed a little relative to an applying time of the rising ramp signal.

9. The plasma display panel device as claimed in claim 8, wherein the floating voltage is supplied to a sustain electrode of the display panel.

10. The plasma display panel device as claimed in claim 9, wherein the floating voltage includes a section of a sustain potential for sustaining the applying voltage, and wherein a sustain voltage amplitude is variable dependant on a load rate.

11. The plasma display panel device as claimed in claim 10, wherein the sustain voltage amplitude increases as the load rate decreases.

12. The plasma display panel device as claimed in claim 3, wherein the load rate is at least one of average signal levels including power consumption of a period per unit, a ratio of a display discharging cell to a non-display discharging cell in a period per unit, and gray level weighted values of a display discharging cell.

13. The plasma display panel device as claimed in claim 12, wherein the period per unit is one of a sub-field period and a frame period (TV field).

14. A driving method of a plasma display panel device, comprising the steps of:
preparing a data signal to receive an image signal;
calculating a load rate from the data signal;
preparing a control signal of reset glow due to the load rate; and,
executing a control operation of reset glow in response to the control signal of reset glow.

15. The driving method of claim 14, wherein the control signal is a ramp control signal supplied to a scan driver for varying a reset signal and a floating control signal for controlling a driving signal from a sustain driver during a reset period.

16. The driving method of claim 15, wherein the ramp control signal is a variable control signal for varying a peak-voltage of a rising ramp signal in reset signals.

17. The driving method of a plasma display panel device as claimed in claim 16, wherein an amplitude of the peak-voltage reduces as the load rate reduces.

18. The driving method of a plasma display panel device as claimed in claim 15, wherein a floating voltage is less than a voltage of a rising ramp signal.

19. The driving method of claim 15, wherein the load rate is at least one of average signal levels including power consumption of a period per unit, a ratio of a display discharging cell to a non-display discharging cell in a period per unit, and gray level weighted values of a display discharging cell.

20. The driving method of claim 19, wherein the period per unit is one of a sub-field period and a frame period.

21. The driving method of claim 14, wherein one of preparing the control signal and executing the control operation comprises:
selecting a peak-voltage due to a load rate;
preparing a ramp control signal including a value of a selected peak-voltage selected; and
applying a rising ramp signal in response to the ramp control signal.

22. The driving method of claim 14, wherein one of preparing the control signal and executing the control operation comprises:
selecting a sustain potential which sustains constantly a potential of a floating voltage due to the load rate;
preparing a floating control signal including a value of sustain potential;
applying a rising ramp signal of reset signals; and
supplying a floating voltage in response the rising ramp signal.

23. The driving method of claim 22, wherein the floating voltage is supplied while being delayed a little relative to an applying time of the rising ramp signal.

24. The driving method of claim 23, wherein a sustain voltage amplitude increases as the load rate decreases.
